(19) United States
(12) Patent Application Publication
(10) Pub. No.: US 2020/0394244 A1
(43) Pub. Date: Dec. 17, 2020

(54) System And Method For Matching A User To Another Entity

(71) Applicant: Tera Dating, Inc., Detroit, MI (US)

(72) Inventor: Jacob FRIEDMAN, Detroit, MI (US)

(21) Appl. No.: 16/439,362

(22) Filed: Jun. 12, 2019

(51) Int. Cl. G06F 16/9536; G06N 3/08; G06N 20/00; H04L 12/58; G06F 3/0484; G06F 16/9538

(52) U.S. Cl. CPC G06F 16/9536; G06N 3/08; G06N 20/00; G06F 16/9538; H04L 51/046; G06F 3/04847; H04L 51/32

(57) ABSTRACT

In an example, a system is disclosed. The system includes at least one processor and a computer-readable medium configured to store instructions for execution by the at least one processor. The instructions include: receiving login credentials from a client device corresponding to a user profile; presenting an entity profile at a display of the client device, wherein the entity profile is within a scoring category of the user profile; presenting a scoring graphical interface at the display corresponding to the entity profile, wherein the scoring graphical interface includes a scoring dial; and updating a score of the entity profile in response to receiving the score from the client device.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to matching systems and more particularly to a matching process system and method.

Computer systems have been used to provide matching services that match people having similar and/or compatible character traits and/or values.

### SUMMARY

In an example, a system is disclosed. The system includes at least one processor and a computer-readable medium configured to store instructions for execution by the at least one processor. The instructions include: receiving login credentials from a client device corresponding to a user profile; presenting an entity profile at a display of the client device, wherein the entity profile is within a scoring category of the user profile; presenting a scoring graphical interface at the display corresponding to the entity profile, wherein the scoring graphical interface includes a scoring dial; and updating a score of the entity profile in response to receiving the score from the client device.

In other features, the instructions include updating the scoring category of the entity profile based on the updated score, wherein the scoring category is associated with a hue.

In other features, the instructions include: receiving a request to generate a user-generated query corresponding to the entity profile; generating the user-generated query; and sending the user-generated query to the entity profile.

In other features, the instructions include: receiving a request to select a gift corresponding to the entity profile; initiating payment authentication for the gift; and sending the payment authentication to an electronic commerce server corresponding to the gift.

In other features, the instructions include: receiving a first image from the client device; receiving a second image from the client device; determining whether a user is included in the first image and the second image; and generating an alert indicating the user is not in the first image or the second image.

In other features, a machine learning network determines whether the user is included in the first image and the second image.

In other features, the machine learning network includes at least one of a supervised learning network, an unsupervised learning network, a semi-supervised learning network, a reinforcement learning network, or a convolutional neural network.

In other features, the instructions include receiving a request to send a communication to the entity profile from the client device and sending the communication to the entity profile.

In other features, the scoring dial comprises a plurality of ticks corresponding to discrete scoring levels ranging between a lower scoring threshold and an upper scoring threshold.

In other features, the scoring graphical interface includes a booster scoring interface representing a score that is greater than an upper scoring threshold of the scoring dial.

In an example, a method is disclosed. The method includes receiving login credentials from a client device corresponding to a user profile; presenting an entity profile at a display of the client device, wherein the entity profile is within a scoring category of the user profile; presenting a scoring graphical interface at the display corresponding to the entity profile, wherein the scoring graphical interface includes a scoring dial; and updating a score of the entity profile in response to receiving the score from the client device.

In other features, the method includes updating the scoring category of the entity profile based on the updated score, wherein the scoring category is associated with a hue.

In other features, the method includes: receiving a request to generate a user-generated query corresponding to the entity profile; generating the user-generated query; and sending the user-generated query to the entity profile.

In other features, the method includes: receiving a request to select a gift corresponding to the entity profile; initiating payment authentication for the gift; and sending the payment authentication to an electronic commerce server corresponding to the gift.

In other features, the method includes: receiving a first image from the client device; receiving a second image from the client device; determining whether a user is included in the first image and the second image; and generating an alert indicating the user is not in the first image or the second image.

In other features, the method includes determining, via a machine learning network, whether the user is included in the first image and the second image.

In other features, the machine learning network includes at least one of a supervised learning network, an unsupervised learning network, a semi-supervised learning network, a reinforcement learning network, or a convolutional neural network.

In other features, the method includes receiving a request to send a communication to the entity profile from the client device and sending the communication to the entity profile.

In other features, the scoring dial comprises a plurality of ticks corresponding to discrete scoring levels ranging between a lower scoring threshold and an upper scoring threshold.

In other features, the scoring graphical interface includes a booster scoring interface representing a score that is greater than an upper scoring threshold of the scoring dial.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a block diagram of an example system according to an example implementation of the present disclosure;

FIG. 2 is a block diagram of an example client device used by a user to interface with a server within the example system according to an example implementation of the present disclosure;

FIG. 3 is a block diagram of an example server within the example system according to an example implementation of the present disclosure;

FIG. 4 is a block diagram of a profile creation module according to an example implementation of the present disclosure;

FIG. 5 is a block diagram of an entity-matching module according to an example implementation of the present disclosure;

FIG. 6 is an example graphical interface presented to a display of the client device;

FIGS. 7A and 7B are example graphical interfaces presented to a display of the client device;

FIG. 8 is another example graphical interface presented to a display of the client device;

FIG. 9 is another example graphical interface presented to a display of the client device;

FIG. 10 is another example graphical interface presented to a display of the client device;

FIG. 11 is a flow chart illustrating an example method for verifying that multiple images and/or videos represent the user according to an example implementation of the present disclosure;

FIG. 12 is a flow chart illustrating an example method for determining a score for an entity according to an example implementation of the present disclosure; and

FIG. 13 is a flow chart illustrating an example method for presenting one or more entities to a user according to an example implementation of the present disclosure.

In the drawings, reference numbers may be reused to identify similar and/or identical elements.

### DETAILED DESCRIPTION

Below are simplistic examples of a distributed computing environment in which the systems and methods of the present disclosure can be implemented. Throughout the description, references to terms such as servers, client devices, applications and so on are for illustrative purposes only. The terms server and client device are to be understood broadly as representing computing devices with one or more processors and memory configured to execute machine readable instructions. The terms application and computer program are to be understood broadly as representing machine readable instructions executable by the computing devices.

The present disclosure is directed to a system for matching a user with one or more entities having a profile. In one or more implementations, the user creates a profile that is stored within the system. The profile can include data about the user. For example, the data can include, but is not limited to, text, video, voice, images, or the like that provides information about the user. Once the user has created a profile, the user can be presented with one or more profiles of entities (e.g., other users) based on one or more criteria. In an implementation, the system may initially set a score for the user's profile to an upper score threshold (e.g., “10” on a scale of 0 to 10). The user may be presented with entities within the same scoring category as described in greater detail below. The user can then provide a user-selected score for the entity presented, initiate a communication with the entity, send a gift to the entity, or the like.

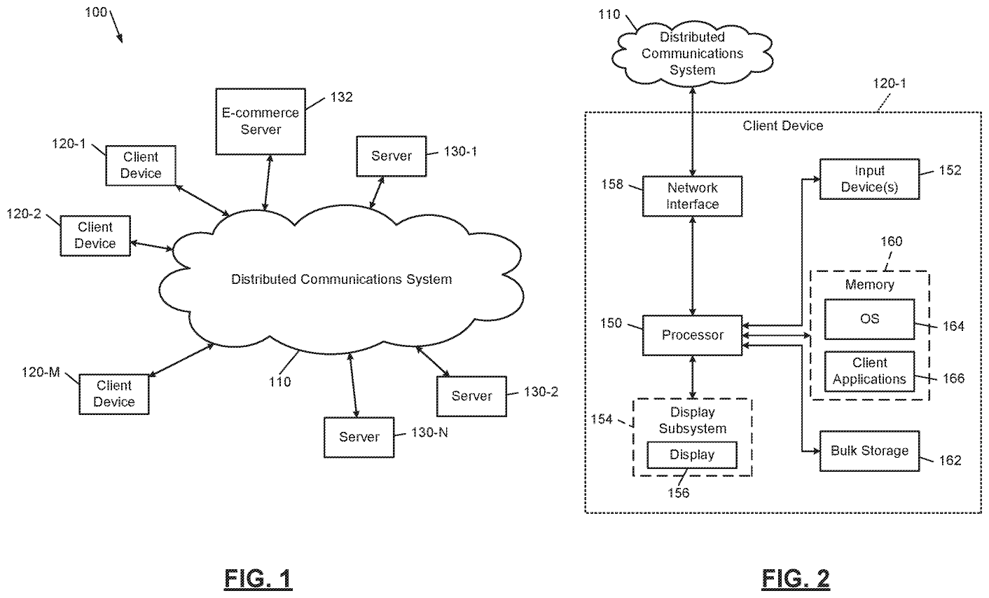

FIG. 1 shows a simplified example of a system 100 for matching the user with another entity. The system 100 includes a distributed communications system 110, one or more client devices 120-1, 120-2, . . . , and 120-M (collectively, client devices 120), and one or more servers 130-1, 130-2, . . . , and 130-N (collectively, servers 130). M and N are integers greater than or equal to one. The distributed communications system 110 may include a local area network (LAN), a wide area network (WAN) such as the Internet, or other type of network. The client devices 120 and the servers 130 may be located at different geographical locations and communicate with each other via the distributed communications system 110. The client devices 120 and the servers 130 connect to the distributed communications system 110 using wireless and/or wired connections.

The client devices 120 may include smartphones, personal digital assistants (PDAs), tablets, laptop computers, personal computers (PCs), etc. The servers 130 may provide multiple services to the client devices 120. For example, the servers 130 may execute software applications developed by one or more vendors. The servers 130 may host multiple databases that are relied on by the software applications in providing services to users of the client devices 120.

The client devices 120 are able to connect to a web service, and the servers 130 may individually or collectively implement systems according to the present disclosure.

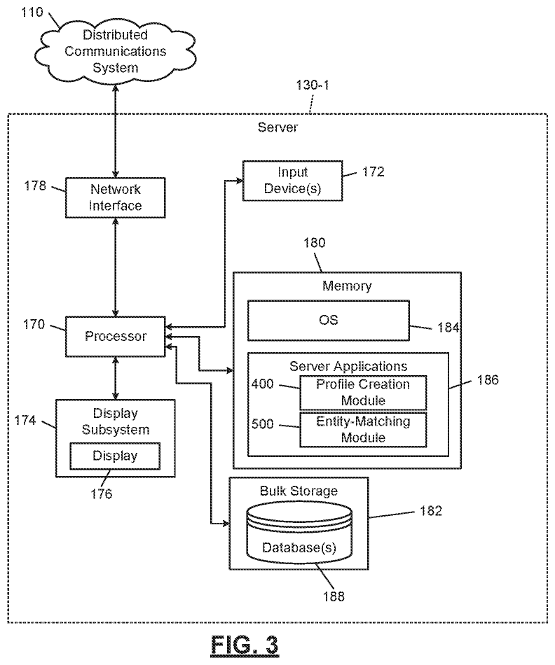

FIG. 2 shows a simplified example of the client device 120-1. The client device 120-1 may typically include a central processing unit (CPU) or processor 150, one or more input devices 152 (e.g., a keypad, touchpad, mouse, touchscreen, etc.), a display subsystem 154 including a display 156, a network interface 158, memory 160, and bulk storage 162.

The network interface 158 connects the client device 120-1 to the distributed computing system 100 via the distributed communications system 110. For example, the network interface 158 may include a wired interface (for example, an Ethernet interface) and/or a wireless interface (for example, a Wi-Fi, Bluetooth, near field communication (NFC), or other wireless interface). The memory 160 may include volatile or nonvolatile memory, cache, or other type of memory. The bulk storage 162 may include flash memory, a magnetic hard disk drive (HDD), and other bulk storage devices.

The processor 150 of the client device 120-1 executes an operating system (OS) 164 and one or more client applications 166. The client applications 166 include an application that accesses the servers 130 via the distributed communications system 110.

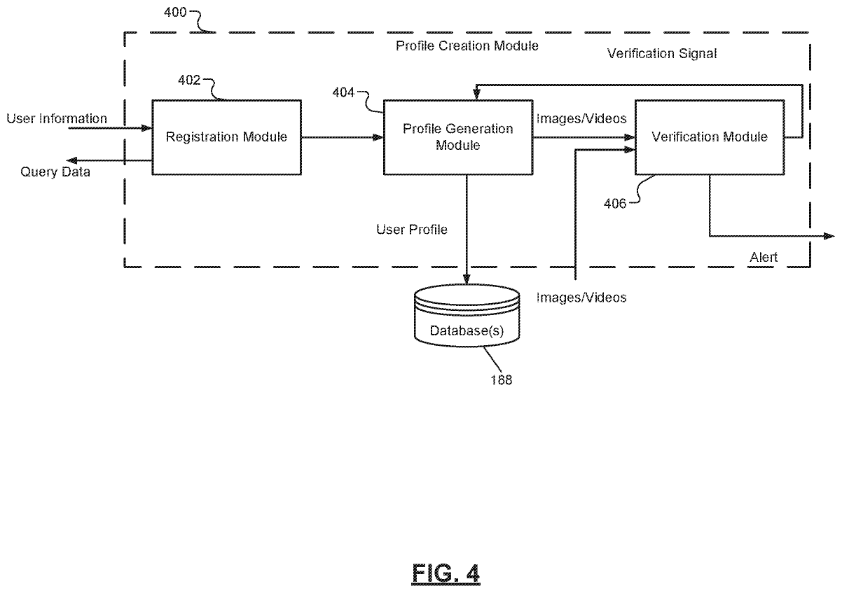

FIG. 3 shows a simplified example of the server 130-1. The server 130-1 typically includes one or more CPUs or processors 170, a network interface 178, memory 180, and bulk storage 182. In some implementations, the server 130-1 may include one or more input devices 172 (e.g., a keypad, touchpad, mouse, and so on) and a display subsystem 174 including a display 176.

The network interface 178 connects the server 130-1 to the distributed communications system 110. For example, the network interface 178 may include a wired interface (e.g., an Ethernet interface) and/or a wireless interface (e.g., a Wi-Fi, Bluetooth, near field communication (NFC), or other wireless interface). The memory 180 may include volatile or nonvolatile memory, cache, or other type of memory. The bulk storage 182 may include flash memory, one or more magnetic hard disk drives (HDDs), or other bulk storage devices.

The processor 170 of the server 130-1 executes an operating system (OS) 184 and one or more server applications 186. The bulk storage 182 may store one or more databases 188 that store data structures used by the server applications 186 to perform respective functions. The server applications 186 can include a profile creation module 400 and an entity-matching module 500, which are described in greater detail herein.

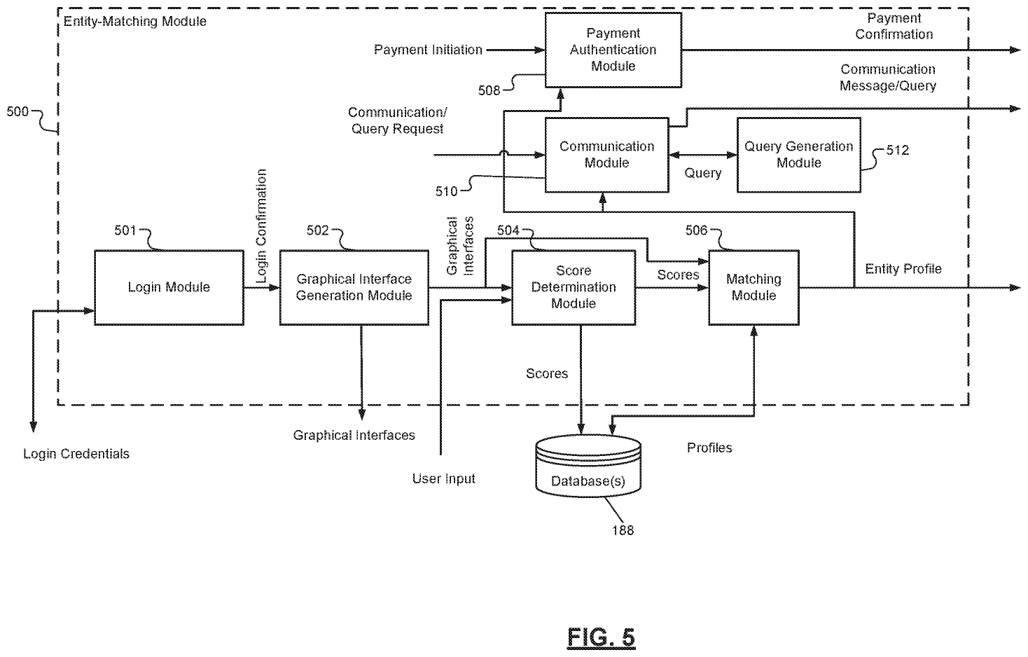

FIG. 4 illustrates an example profile creation module 400 according to an example implementation of the present disclosure. The profile registration module 400 may comprise one of the server applications 186 stored in the memory 180. The profile registration module 400 includes a registration module, 402, a profile generation module 404, a machine learning module 406, and a determination module 408.

The registration module 402 provides query data to the client devices 120-1 to 120-M requesting a response from the user and receives responsive data from the client devices 120-1 to 120-M. The query data may include, but is not limited to, a series of questions which identifies characteristics about the user. For instance, the characteristics can include the height, weight, age, location, and ethnicity of the user. It may also include requests regarding the birthplace, parents, eating habits, activities, and goals of the user. In some instances, the query data may include requests regarding what the user may be looking for in a match, such as age, weight, height, location, ethnicity, diet, education, and the like. The registration module 402 may also request data regarding how important certain factors are when looking for a match. For example, the user may provide data indicative of which characteristics in a potential match are a requirement.

The registration module 402 can provide the received data to the profile generation module 404. The profile generation module 404 generates a profile based on the received data. The profile generation module 404 can also request multiple images and/or videos representative of the user. Upon receiving the images and/or videos, the profile generation module 404 provides the images and/or videos to the verification module 406 for verification.

The verification module 406 verifies the multiple images and/or videos represent the same user among the provided images and/or videos. The verification module 406 can use one or more machine learning process to compare the images and/or videos to verify the images and/or videos represent the same user. The machine learning process can include, but are not limited to: a supervised learning network, an unsupervised learning network, a semi-supervised learning network, a reinforcement learning network, a convolutional neural network, or the like.

If the verification module 406 determines the images and/or videos represent the same user, the verification module 406 provides a verification signal to the profile generation module 404. The profile generation module 404 can complete the profile corresponding to the user and store the profile in the database 188. It is understood that the verification module 406 may also verify whether the images and/or videos represent the same user using other suitable verification processes.

If the verification module 406 determines the images and/or videos do not represent the same user, the verification module 406 generates an alert signal that is provided to the client device 120-1 to 120-M of the user indicating the images and/or videos do not match the user. The user can then provide additional images and/or videos to the verification module 406.

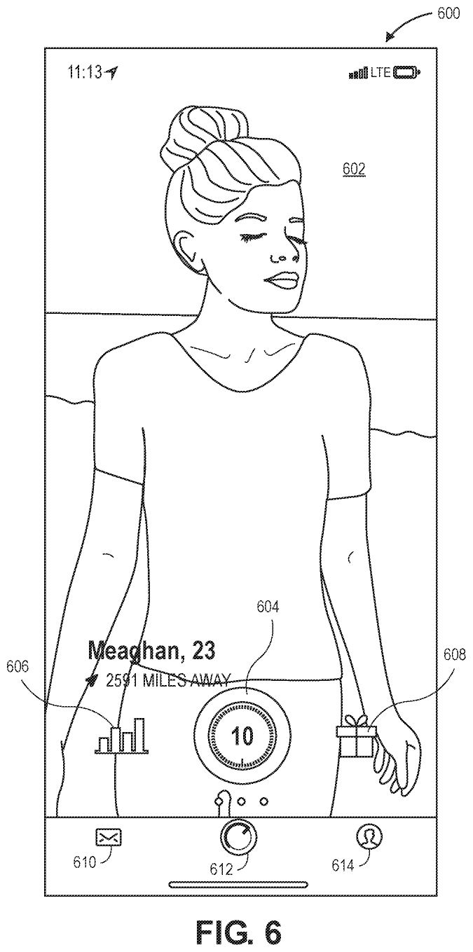

FIG. 5 illustrates an example entity-matching module 500 according to an example implementation of the present disclosure. The match-making module 500 may comprise one of the server applications 186 stored in the memory 180. The match-making module 500 includes a login module 501, a graphical interface generation module 502 a score determination module 504, a matching module 506, a payment authentication module 508, a communication module 510, and a query generation module 512.

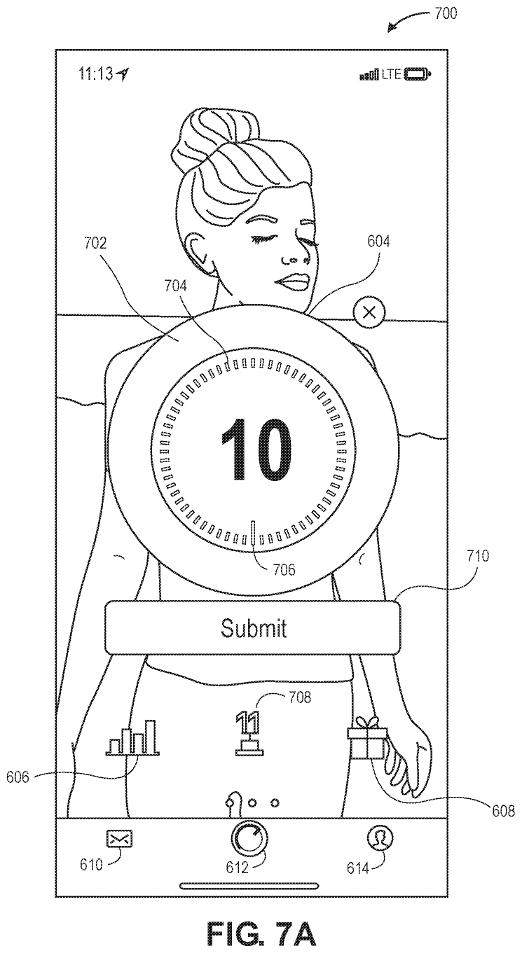

Using a client device 120-1 to 120-M, a user can communicate with the match-making module 500. For example, the graphical interface generation module 502 generates one or more graphical user interfaces at the user's client device 120-1 to 120-M. FIGS. 6 through 10 illustrate example graphical interfaces 600, 700, 800, 900, 1000 generated at the display 156 of the client device 120-1.

Upon interfacing with the application via the client device 120-1, the login module 501 requests login credentials from the user. If the user provides the correct credentials to the login module 501, the graphical interface generation module 502 generates the graphical interface 600 that includes a picture 602 of an entity matched with the user based on the matching module 504. The graphical interface 600 also includes a scoring interface 604, a profile interface 606, and a gift interface 608. The user can interface with the interfaces 604, 606, 608 by providing a touch input to the desired interface 604, 606, 608 via the display 156.

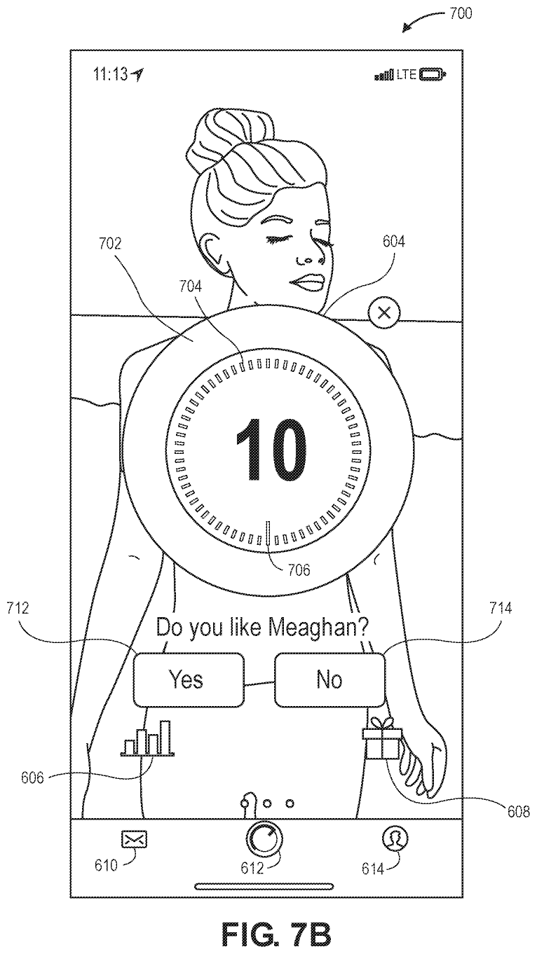

FIG. 7A illustrates an example of the scoring interface 604. The user can provide an appearance score via the scoring interface 604. In an implementation, the scoring interface 604 may allow the user to provide a score between 0.0 and 10.0. For example, scoring interface 604 can initially provide a score of “10” and the user can manipulate the scoring interface 604 via touch input to alter the score. In one example, the user can manipulate a dial 702 representing the scoring interface 604. The dial 702 includes multiple ticks 704 corresponding to discrete scoring levels and a set-point tick 706 corresponding to lower (“0”) and/or upper (“10”) scoring threshold. In some examples, each discrete scoring level may be half a point. However, other scoring level implementations are contemplated.

The scoring interface 604 may also include a booster scoring interface 708 that allows the user to provide a boosted score that is greater than the upper scoring threshold. For example, if the upper scoring threshold is “10,” the boosted score may be “11.” Once the user has manipulated the dial 702 or interfaced with the booster scoring interface 708, the client device 120-1 provides the desired score to the match-making module 500 via an input interface 710 or the booster scoring interface 708.

The score determination module 504 receives the score and calculates an overall score associated with the entity. For example, the score determination module 504 may calculate the overall score by taking the average of the scores provided multiple users.

The overall scores of each entity is provided to the matching module 506, and the matching module 506 presents, or matches, the entity with other entities based on the overall score. In an implementation, the matching module 506 selects entity profiles to present to the user based, in part, on scoring stratification. Scoring stratification defines discrete scoring categories based on upper and lower scoring thresholds. For instance, a first scoring category may be defined for entities having an overall score ranging from “8.0” to “10,” a second scoring bin may be defined for entities having an overall score ranging from “6.0” to “7.9,” and so forth. In this implementation, a user having an overall score of “8.5” would be presented with entities within the first scoring category.

In some implementations, a user may be presented with profiles of entities in scoring categories having lesser overall scores. In some implementations, a user having an overall score within a lower scoring category would not be presented with entities in a higher scoring category unless the user has initiated a payment authentication allowing the user to view profiles of entities within the first scoring bin. For example, the user can initiate a payment via the payment authentication module 508 to be presented with entities in higher scoring categories.

Once the user has provided a score for the entity's profile the input interface 710 or the booster scoring interface 708, the user is presented with another graphical interface that includes interfaces 712, 714. As shown, the interface 712 can be represented by a “YES” button, and the interface 714 can be represented by a “NO” button.

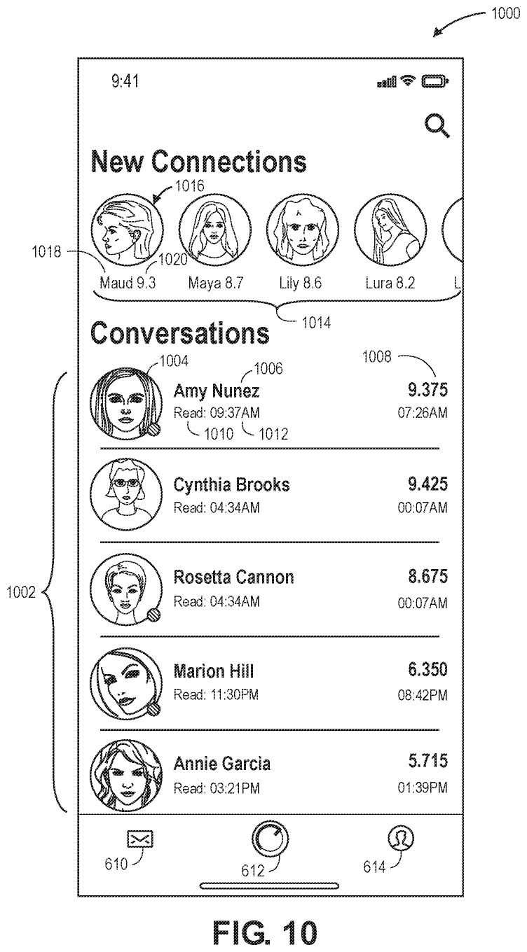

In one or more implementations, the interfaces 712, 714 can be used by the user to signify an interest in the entity. As described in greater detail below, if both the user and the entity demonstrate a mutual interest by selecting the interface 712, the user's profile and the entity's profile can be included within a “New Connections” listing (see FIG. 10).

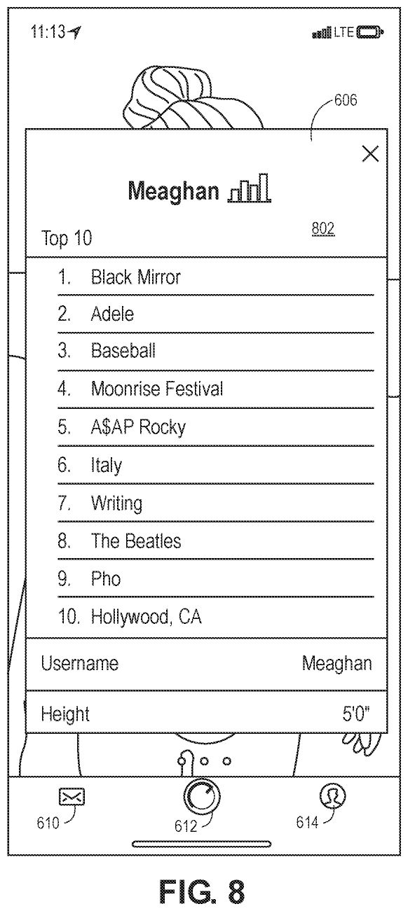

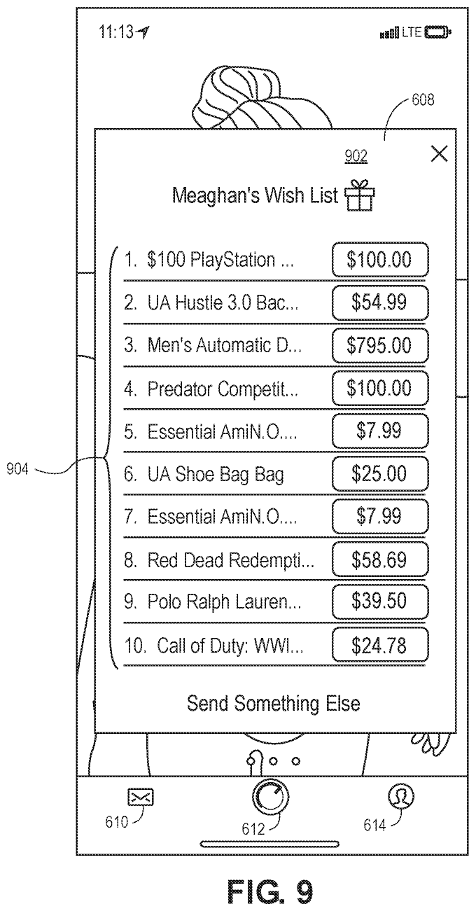

FIG. 8 illustrates an example profile interface 606 illustrating the entities likes and/or interests. As shown, the profile interface 606 includes a graphic 802 illustrating the entities “Top 10” list of interests. FIG. 9 illustrates an example gift interface 608. The gift interface 608 includes a graphic 902 presenting multiple gifts 904 for the entity. The user can initiate purchase of a gift 904 by providing a touch input corresponding to the desired gift. Once the user has selected the desired gift 904 via the gift interface 608, the gift interface 608 initiates the payment authentication module 508 to complete the transaction. The payment authentication module 508 may then transmit a signal to the e-commerce server 132 that send or provide the gift to the entity. The signal may include a transaction confirmation, entity contact and/or shipping information, and/or gift information. Users can populate gifts within the user's profile by providing a Uniform Resource Locator (URL) address associated with the gift. For example, the user can provide a URL associated with an electronic commerce (e-commerce) web server 132 that offers the gift for sale.

FIG. 10 illustrates an example interface 1000 that allows the user to communicate with one or more entities. In an implementation, the user can initiate communication with the entity by selecting a communication interface 610, which is described in greater detail below. The interface 1000 includes a listing 1002 of entity profiles for which the user has previously submitted a score. As shown, each listing 1002 includes an entity's picture 1004, entity's name 1006, and the entity's score 1008. Each listing 1002 may also include data 1010 indicating whether the communication has been accessed by the entity and, if accessed, data 1012 indicating the time the communication was accessed by the entity.

The interface 1000 also includes a listing 1014 of new connections. The listing 1014 includes an entity's picture 1016, an entity's name 1018, and an entity's score 1020. In one or more implementations, the listing 1014 is generated and displayed based on mutual interest confirmation. For example, if both the user and the entity have both indicated an interest in one another by selecting interface 712 (“YES” button), the entity's profile can be included in the listing 1014 and the user's profile can be included in the entity's listing. In one or more implementations, the entity scores 1008, 1020 may be displayed in a specific hue. For example, entity scores within the first scoring category may be displayed in a first hue (e.g., green), and entity scores within the second scoring category may be displayed in a second hue (e.g., yellow), and so on.

As shown in FIGS. 6 through 10, each interface 600, 700, 800, 900, 1000 may also include a communication interface 610, current entity profile interface 612, and profile interface 614. The communication interface 610 allows the user to initiate a communication with the corresponding entity. For example, by selecting the communication interface 610 via touch input, the user can generate a communication to be sent to the entity via the communication module 510. In some implementations, the communication may include a user-generated query that can be send to the entity to request additional information from the entity. For example, the user-generated query may include requests for information regarding additional likes, dislikes, and/or items to rate. In an implementation, the user-generated query comprises a predetermined number of queries related to discrete topics, such as “politics,” “movies,” or the like. The user-generated query can be generated via the query generation module 512 and transmitted to the entity via the communication module 512.

The current profile interface 612 can return the user to the profile of the current entity, which is illustrated as the graphical interface shown in FIG. 6. The profile interface 614 allows the user to view the user's profile information. The user can provide payment information to purchase gifts or upgrades. In some instances, the user can remove the user's current score such that the current score does not factor into future scorings. The user can initiate removing the score using the payment authentication module 508, which sends a signal to the score determination module 504 to remove (e.g., delete) the current score.

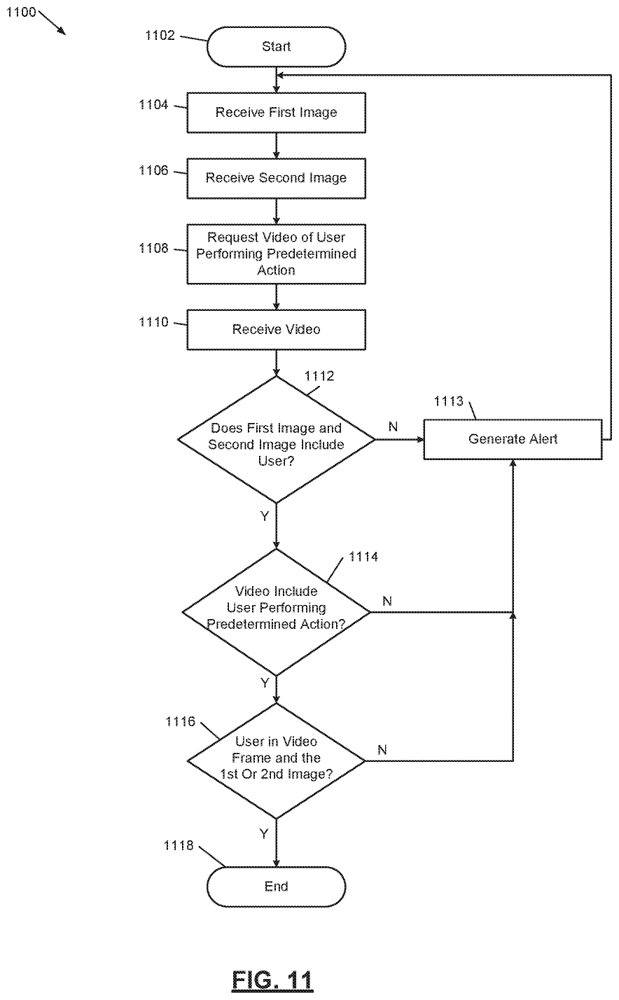

FIG. 11 illustrates an example method 1100 for verifying that multiple images and/or videos represent the user creating the profile. The method 1100 at 1102. At 1104 a first image is received from a client device 120-1 of the user. At 1106, a second image is received from the client device 120-1. The second image is a different image with respect to the first.

At 1108, a request is transmitted to the client device 120-1 requesting the user perform one or more predetermined actions corresponding to the request. For example, the request may be a video of another entity performing the predetermined actions. At 1110, a video is received from the client device 120-1 in response to the request. At 1112, a determination is made whether the first image and the second image represent the same user. For example, one or more machine learning techniques can be used to determine whether the first image and the second image represent the same user. If it is determined that the first image and the second image do not include the same user, the method 1100 generates an alert indicating the mismatch at 1113 and returns to 1104.

If it is determined that the first image and the second image represent the same user, a determination is made whether the video includes the user performing the one or more predetermined actions included in the request at 114. In an implementation, one or more machine learning techniques are used by the method 1100 to compare the video with the request. If the video does not include the user performing the predetermined action, the method 1100 returns to 1113 to indicate there the user is not performing the predetermined action.

In some implementations, if the determination is made that the video includes the user is performing the predetermined action, a comparison of at least one video frame is compared with one of the first and/or second images to determine whether the user within the video frame matches the user within the first and/or second image at 1116. If the user in the video frame does not match the user in the first and/or second image, the method 1100 returns to 1104. If the user in the video frame does match the user in the first and/or second image, the method 1100 ends at 1118.

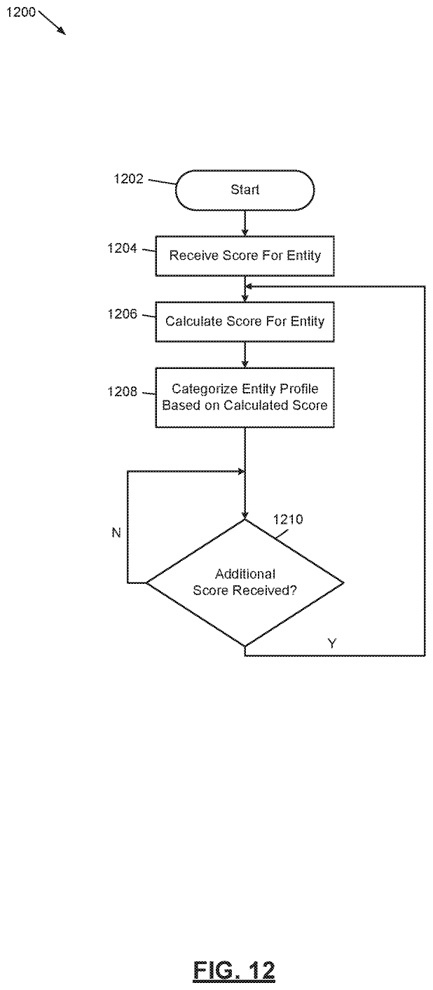

FIG. 12 illustrates an example method 1200 for determining a score for an entity. The method 1200 begins at 1202. At 1204, a score is received for the entity. At 1206, the score for the entity is calculated. For example, the score may be calculated based on the mean average of the scores received for the entity. At 1208, the profile of the entity is categorized based on the score. At 1210, the method 1200 determines whether an additional score is received from another client device associated with another user profile. If another score is received, the method 1200 returns to 1206. If no additional score is received, the method 1200 returns to 1210.

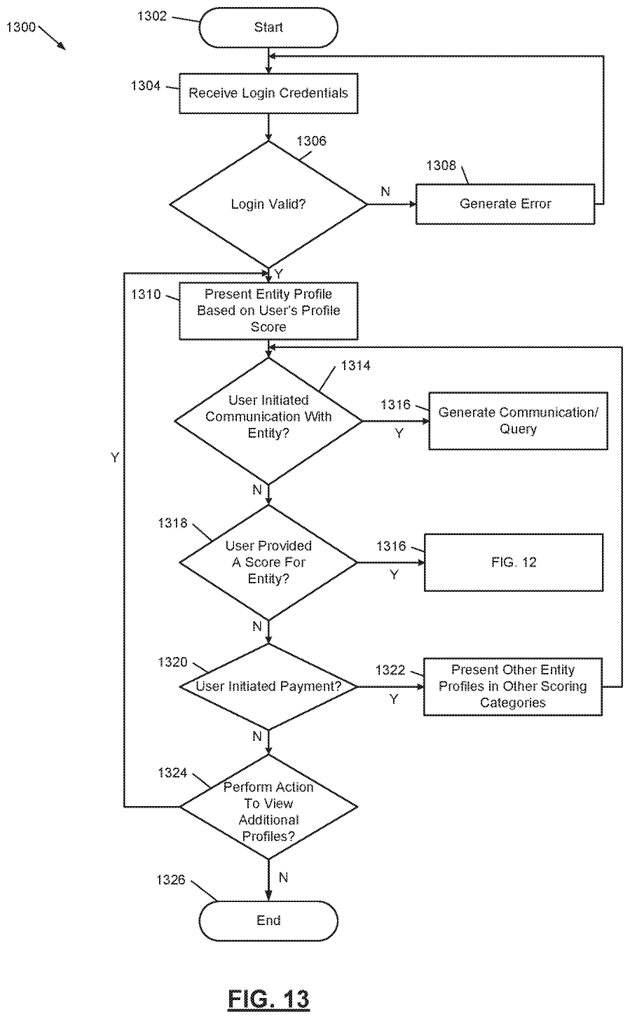

FIG. 13 illustrates an example method 1300 for presenting one or more entities to a user. The method 1300 begins at 1302. At 1304, login credentials are received. At 1306, a determination is made whether the login credentials match the stored credentials corresponding to the user. If the login credentials do not match, an error message is generated at 1308, and the method 1300 returns to 1304.

If the login credentials match, an entity profile is presented to user at 1310. The entity profile is selected by the matching module 506 based on the user's profile score. For example, the user may only be presented with entity profiles having a score within the same score category. The method 1300 determines whether the user has initiated a communication with entity profile presented at 1314. If the user has initiated communication with the entity profile, the method 1300 allows the user to generate a communication and/or user-generated query for the entity at 1316. Once the user-generated query or the communication has been sent, the user can be presented with a graphical interface similar to the interface show in FIG. 10. For example, the interface can include a listing 1002 of entities for which the user/entity has initiated communication with one another and a listing 1014 of entities for which there is an initiated mutual interest. If the user has not initiated communication with the entity profile, the method 1300 determines whether the user has provided a score for the entity profile at 1318.

If the user has provided a score, the method 1300 transitions to method 1200 described above and illustrated in FIG. 12. If no score has been provided, the method 1300 determines whether the user has initiated a payment to view entity profiles in other categories at 1320. If the user has initiated payment, the method 1300 presents the user with an entity having a score within another score category at 1322. If the user has not initiated the payment, the method 1300 determines whether the user has performed an action to view another entity within the same score category as the user at 1324. If the user has not performed an action to view another entity, the method 1300 ends at 1326. If the user has performed an action to view another entity, the method 1300 returns to 1310.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A system comprising:
at least one processor; and
a computer-readable medium configured to store instructions for execution by the at least one processor, wherein the instructions include:
receiving login credentials from a client device corresponding to a user profile;
presenting an entity profile at a display of the client device, wherein the entity profile is within a scoring category of the user profile;
presenting a scoring graphical interface at the display corresponding to the entity profile, wherein the scoring graphical interface includes a scoring dial; and
updating a score of the entity profile in response to receiving the score from the client device.

2. The system as recited in claim 1, wherein the instructions include:
updating the scoring category of the entity profile based on the updated score, wherein the scoring category is associated with a hue.

3. The system as recited in claim 1, wherein the instructions include:
receiving a request to generate a user-generated query corresponding to the entity profile;
generating the user-generated query; and
sending the user-generated query to the entity profile.

4. The system as recited in claim 1, wherein the instructions include:
receiving a request to select a gift corresponding to the entity profile;
initiating payment authentication for the gift; and
sending the payment authentication to an electronic commerce server corresponding to the gift.

5. The system as recited in claim 1, wherein the instructions include:
receiving a first image from the client device;
receiving a second image from the client device;
determining whether a user is included in the first image and the second image; and
generating an alert indicating the user is not in the first image or the second image.

6. The system as recited in claim 5, wherein a machine learning network determines whether the user is included in the first image and the second image.

7. The system as recited in claim 6, wherein the machine learning network includes at least one of a supervised learning network, an unsupervised learning network, a semi-supervised learning network, a reinforcement learning network, and a convolutional neural network.

8. The system as recited in claim 1, wherein the instructions include:
receiving a request to send a communication to the entity profile from the client device; and
sending the communication to the entity profile.

9. The system as recited in claim 1, wherein the scoring dial comprises a plurality of ticks corresponding to discrete scoring levels ranging between a lower scoring threshold and an upper scoring threshold.

10. The system as recited in claim 1, wherein the scoring graphical interface includes a booster scoring interface representing a score that is greater than an upper scoring threshold of the scoring dial.

11. A method comprising:
receiving login credentials from a client device corresponding to a user profile;
presenting an entity profile at a display of the client device, wherein the entity profile is within a scoring category of the user profile;
presenting a scoring graphical interface at the display corresponding to the entity profile, wherein the scoring graphical interface includes a scoring dial; and
updating a score of the entity profile in response to receiving the score from the client device.

12. The method as recited in claim 11, further comprising:
updating the scoring category of the entity profile based on the updated score, wherein the scoring category is associated with a hue.

13. The method as recited in claim 11, further comprising:
receiving a request to generate a user-generated query corresponding to the entity profile;
generating the user-generated query; and
sending the user-generated query to the entity profile.

14. The method as recited in claim 11, further comprising:
receiving a request to select a gift corresponding to the entity profile;
initiating payment authentication for the gift; and
sending the payment authentication to an electronic commerce server corresponding to the gift.

15. The method as recited in claim 11, further comprising:
receiving a first image from the client device;
receiving a second image from the client device;
determining whether a user is included in the first image and the second image; and
generating an alert indicating the user is not in the first image or the second image.

16. The method as recited in claim 15, further comprising: learning, via a machine learning network, whether the user is included in the first image and the second image.

17. The method as recited in claim 16, wherein the machine learning network includes at least one of a supervised learning network, an unsupervised learning network, a semi-supervised learning network, a reinforcement learning network, or a convolutional neural network.

18. The method as recited in claim 11, further comprising:
receiving a request to send a communication to the entity profile from the client device; and
sending the communication to the entity profile.

19. The method as recited in claim 11, wherein the scoring dial comprises a plurality of ticks corresponding to discrete scoring levels ranging between a lower scoring threshold and an upper scoring threshold.

20. The method as recited in claim 11, wherein the scoring graphical interface includes a booster scoring interface representing a score that is greater than an upper scoring threshold of the scoring dial.
